(19) United States
(12) Patent Application Publication
(10) Pub. No.: US 2023/0006588 A1
(43) Pub. Date: Jan. 5, 2023

(54) METHOD FOR STARTING MOTOR

(71) Applicant: NIDEC CORPORATION, Kyoto (JP)

(72) Inventors: Pei-Chun SHIH, Taipei City (TW); Hsin-Nan LIN, Taipei City (TW); Yu-Wei HSU, Taipei City (TW); Ta-Yin LUO, Taipei City (TW); Kuan YANG, Taipei City (TW); Guo-Jhih YAN, Taipei City (TW); Sheng-Chan YEN, Taipei City (TW); Cheng-Tsung LIU, Kaohsiung (TW)

(21) Appl. No.: 17/837,043

(22) Filed: Jun. 10, 2022

(30) Foreign Application Priority Data
Jun. 30, 2021 (JP) 2021-108361

(51) Int. Cl. H02P 21/34; H02P 1/26; H02K 1/24

(52) U.S. Cl. CPC H02P 21/34; H02P 1/26; H02K 1/246

(57) ABSTRACT

A method for starting a motor having a stator and a rotor is provided. The method includes starting a motor with field coils of the stator being in Y connection, switching the connection of the field coils to Δ connection when the speed of the rotor does not fall within a predetermined range from a rated speed within a predetermined time (t2), and switching the connection of the field coils to the Y connection when the speed of the rotor falls within the predetermined range from the rated speed.

### CROSS-REFERENCE TO RELATED APPLICATIONS

The present invention claims priority under 35 U.S.C. § 119 to Japanese Patent Application No. 2021-108361 filed on Jun. 30, 2021, the entire content of which is incorporated herein by reference.

### FIELD OF THE INVENTION

The present invention relates to a method for starting a motor used for starting a synchronous reluctance motor.

### BACKGROUND

A technique is known in which voltage is applied with coils of an induction motor being in star connection at the time of starting, and voltage is applied with the coils being in delta connection after the starting.

However, in the case where the technique described above is used for starting a synchronous reluctance motor, there is a case where starting fails when the inertia of a motor, a load, or the like is large.

### SUMMARY

According to an aspect of a method for starting a motor of the present invention, a method for starting a motor having a stator and the rotor is provided. The method is characterized to include starting a motor with field coils of the stator being in Y connection, switching the connection of the field coils to A connection when the speed of the rotor does not fall within a predetermined range from a rated speed within a predetermined time (t2), and switching the connection of the field coils to the Y connection when the speed of the rotor falls within the predetermined range from the rated speed.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a block diagram illustrating a configuration of a motor drive system according to a first embodiment;

FIG. 2 is a sectional view illustrating an exemplary configuration of a motor;

FIG. 3 is a sectional view illustrating a detailed exemplary configuration of a rotor core of the motor;

FIG. 4 is a flowchart illustrating an example of a starting process;

FIG. 5 is a diagram illustrating an exemplary operation of each unit;

FIG. 6 is a diagram illustrating an exemplary operation of each unit;

FIG. 7 is a diagram illustrating an exemplary operation of each unit; and

FIG. 8 is a diagram illustrating examples of success and failure of inertia, load, and start.

### DETAILED DESCRIPTION

Hereinafter, an embodiment for carrying out the present invention will be described in detail with reference to the accompanying drawings.

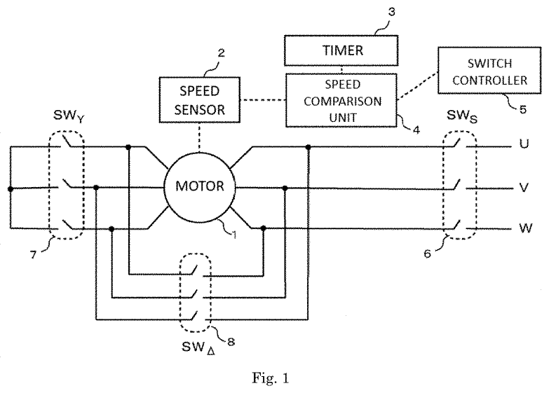

A first embodiment is obtained by applying the present invention to a motor drive system that drives a synchronous reluctance motor. FIG. 1 is a block diagram illustrating an exemplary configuration of the motor drive system according to the present embodiment.

The motor drive system includes a synchronous reluctance motor (motor) 1 to be driven, a speed sensor 2 that detects the rotational speed of the motor 1, a timer 3 that measures a predetermined time, and a speed comparison unit 4 that compares the rotational speed detected by the speed sensor 2 with a predetermined speed. The motor drive system also includes a switch controller 5 that controls switches 6, 7, and 8, the switch (SWₛ) 6 that switches supply of three-phases (U-phase, V-phase, W-phase) power supply voltage from the outside, the switch (SW_{Y}) 7 that switches connection of a coil of the motor 1 to Y connection, and the switch (SW_{Δ}) 8 that switches connection of a coil of the motor 1 to A connection.

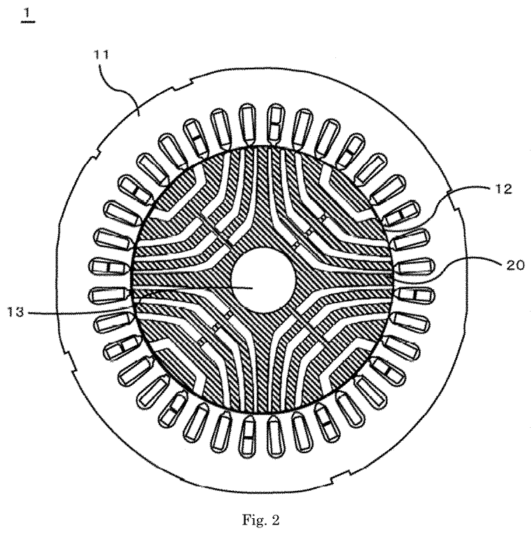

FIG. 2 is a sectional view illustrating an exemplary configuration of the motor 1. FIG. 2 illustrates an example of the four-pole motor 1. FIG. 2 illustrates a section perpendicular to the shaft of the motor 1.

The motor 1 is an inner rotor type motor, and includes an annular stator 11 that generates a field (rotating field) and a rotor 12 provided inside the stator 11. The stator 11 is provided with multiple-phase, for example, three-phase coils that generate a field. The winding method of the coil is illustrated as dispersion winding in the present embodiment, but may be concentrated winding. The rotor 12 includes a shaft 13 and a rotor core 20. The rotor 12 rotates together with the shaft 13.

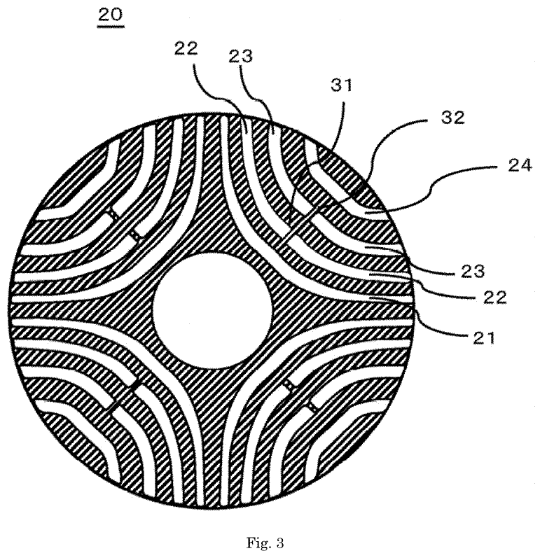

FIG. 3 is a sectional view illustrating a detailed exemplary configuration of the rotor core 20. FIG. 3 also illustrates a section perpendicular to the shaft 13 of the synchronous reluctance motor.

The rotor core 20 is formed by laminating thin plate-shaped magnetic bodies such as silicon steel plates having the shape illustrated in FIG. 3 in a cylindrical shape, and is attached to the shaft 13. The rotor core 20 is provided with a plurality of flux barriers 21, 22, 23, and 24 arranged in the q-axis direction (in this case, the radial direction of the rotor core 20) for each pole.

In order to ensure the strength of the rotor core 20, the flux barriers 22 and 23 are provided with rib-shaped bridges 31 and 32 in the q-axis direction. The width of each of the bridges 31 and 32 in the direction perpendicular to the q-axis is preferably 1 to 2 mm or more in consideration of the strength when a nonmagnetic conductor such as aluminum or copper melted is injected into the flux barrier as described later. Although each of the bridges 31 and 32 is provided at the center (on the q axis) of each of the flux barriers 22 and 23, a plurality of bridges may be provided to one flux barrier.

The thin plate-shaped magnetic material constituting the rotor core 20 can be easily manufactured by punching by a press. The rotor core 20 is formed by laminating a thin plate-shaped magnetic material in a tubular shape and then injecting a non-magnetic conductor such as molten aluminum or copper into the flux barrier portion. This increases the mechanical strength of the rotor core 20.

In addition, ring-shaped conductors are provided at both axial ends of the rotor core 20. These conductors may be formed together with a conductor to be injected into the flux barrier portion.

The conductor of the flux barrier portion and the ring-shaped conductors configured as described above function similarly to the rotor of an induction cage-type induction machine, and generate induction torque in the rotating magnetic field.

A reluctance motor including a rotor having such a configuration may be referred to as a direct-on-line synchronous reluctance motor, but is simply referred to as a synchronous reluctance motor in the present embodiment.

The starting process in the motor drive system configured as described above will be described below.

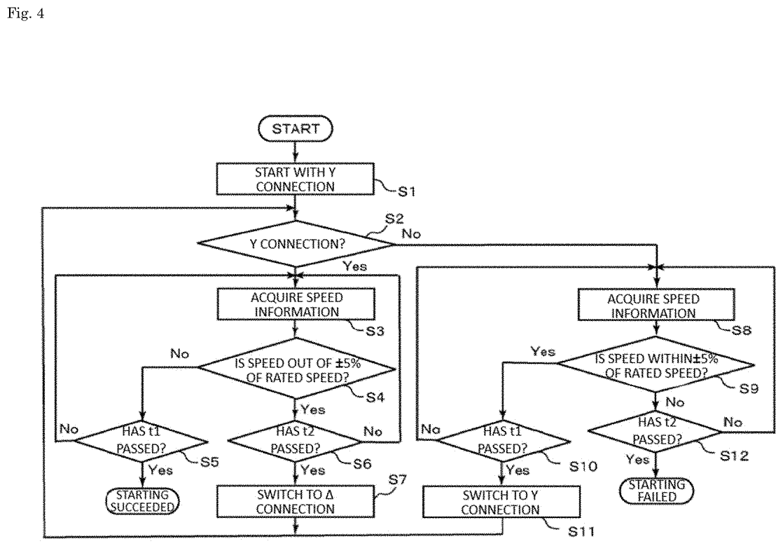

FIG. 4 is a flowchart illustrating an example of a starting process to start a motor in the present embodiment.

For starting the motor 1, first, in S1, the switch controller 5 closes the switch 7, opens the switch 8, switches connection of the coils of the motor 1 to the Y connection, closes the switch 6, supplies the power supply voltage to the motor 1, and starts the motor 1.

In subsequent S2, the switch controller 5 determines whether or not the coils of the motor 1 are currently in the Y connection. If the coils are in the Y connection, the switch controller 5 proceeds to S3, and if not in the Y connection, the switch controller 5 proceeds to S8.

In S3, the switch controller 5 acquires a comparison result (speed information) from the speed comparison unit 4.

Subsequently, in S4, the switch controller 5 determines whether or not the current speed of the motor 1 is out of a predetermined range of the rated speed (for example, out of ±5%) according to the comparison result from the speed comparison unit 4. If the current speed is out of ±5% of the rated speed, the process proceeds to S6, and if not out of ±5% of the rated speed, the process proceeds to S5.

In S5, the switch controller 5 determines whether or not the time after the Y connection is established has passed a predetermined time (for example, t1). If the time has passed, the switch controller 5 determines that the starting has succeeded, and ends the starting process. If the time has not passed, the process returns to S3.

On the other hand, when it is determined in S4 that the current speed of the motor 1 is out of ±5% of the rated speed, the process proceeds to S6, and the switch controller 5 determines whether or not the time from when the Y connection is established has passed a predetermined time (for example, t2). The value of t2 can be, for example, greater than 0 and within about ⅓ of the predicted starting time of the motor. The value of t2 is set according to, for example, at least one of the inertia of the motor 1 or the like and the magnitude of the load.

When the time after the Y connection is established has passed t2, the switch controller 5 proceeds to S7, opens the switch 7, closes the switch 8, switches connection of the coils of the motor 1 to A connection, and returns to S2. When the time after the Y connection is established has not passed t2, the switch controller 5 returns to S3.

With the processing so far, in the present embodiment, when the speed of the motor 1 does not fall within ±5% of the rated speed within a predetermined time (t2) after the coil of the motor 1 is started with the Y connection, the connection of the coils of the motor 1 is switched to the Δ connection.

In S2 executed after the connection of the coil of the motor 1 is switched to the Δ connection, the switch controller 5 determines that the connection is not the Y connection and proceeds to S8.

In S8, the switch controller 5 acquires a comparison result (speed information) from the speed comparison unit 4.

Subsequently, in S9, the switch controller 5 determines whether or not the current speed of the motor 1 is within ±5% of the rated speed according to the comparison result from the speed comparison unit 4. If the current speed is within ±5% of the rated speed, the process proceeds to S10, and if not within ±5% of the rated speed, the process proceeds to S12.

In S10, the switch controller 5 determines whether or not the time from when the A connection is established has passed t1, and when it has passed, the process proceeds to S11.

In S11, the switch controller 5 closes the switch 7, opens the switch 8, switches the connection of the coils of the motor 1 to the Y connection, and returns to S2. When the time after the Δ connection is established has not passed t1, the switch controller 5 returns to S8.

With the operation so far, after the connection of the coils of the motor 1 is switched to the Δ connection, when t1 has passed after the current speed of the motor 1 falls within ±5% of the rated speed, the switch controller 5 switches the connection of the coils of the motor 1 to the Y connection.

As described above, when the current speed of the motor 1 is not within ±5% of the rated speed in S9, the switch controller 5 proceeds to S12, determines whether or not the time from when the A connection is established has passed t2, and when it has not passed, the switch controller 5 returns to S8. When the time after the A connection has passed t2, the switch controller 5 determines that the starting has failed, opens the switch 6 and the switch 8, and ends the starting process.

In this manner, when the starting fails, driving of the motor 1 can be stopped.

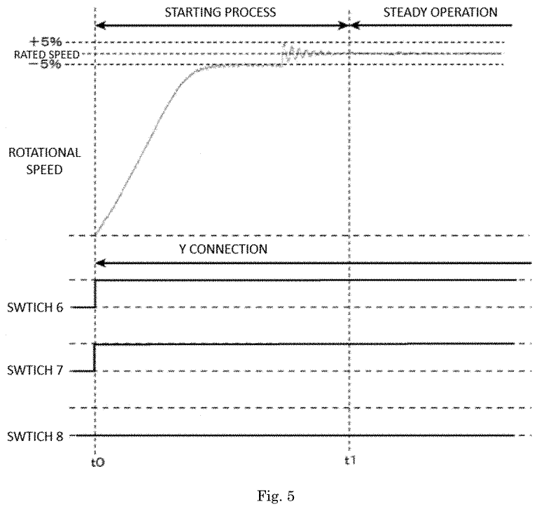

FIG. 5 is a diagram illustrating an exemplary operation of each unit of the motor drive system according to the present embodiment when the inertia is relatively small. In FIG. 5, the switch 6 and the switch 7 are turned ON (connected) at t0, and the ON state is maintained even after t1 has passed. In addition, the switch 8 is OFF at t0, and the OFF state continues even after t1 has passed. The coils of the motor 1 are in the Y connection from t0.

In this case, since the rotational speed of the motor 1 falls within ±5% of the rated speed before t1 has passed after the coils of the motor 1 is connected in the Y connection, switching to the A connection is not performed. Then, after t1 has passed, the starting process is terminated and the operation shifts to the steady operation.

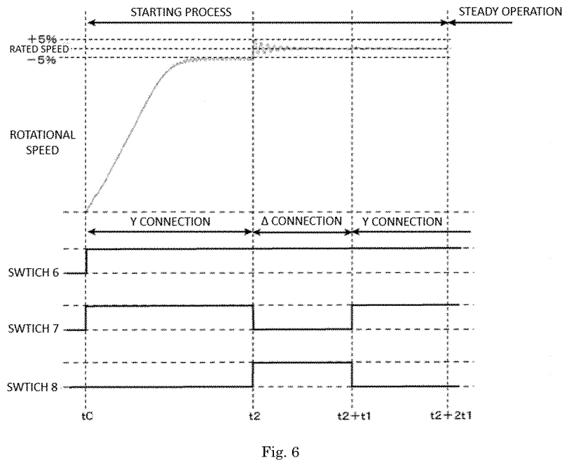

FIG. 6 is a diagram illustrating an exemplary operation of each unit of the motor drive system according to the present embodiment when the inertia is moderate. In FIG. 6, the switch 6 is turned ON (connected) at t0, and the ON state is maintained even after t2 and t2+t1 have passed. The switch 7 is turned ON at t0, turned OFF at t2, and turned ON at t2+t1. The switch 8 is turned OFF at t0, turned ON at t2, and turned OFF at t2+t1. The coils of the motor 1 are in the Y connection from t0 to t2 and in the A connection from t2 to t2+t1.

In this case, since the rotational speed of the motor 1 remains out of ±5% of the rated speed until t2 has passed after the coil of the motor 1 is connected in the Y connection, the connection is switched to the A connection after t2 has passed. After that, since the rotational speed falls within ±5% of the rated speed by the time of passing t1 (before t2+t1), the connection is switched to Y connection when t1 has passed (at t2+t1). Further, after t1 has passed (when t2+2t1), the starting process is terminated, and the operation shifts to the steady operation.

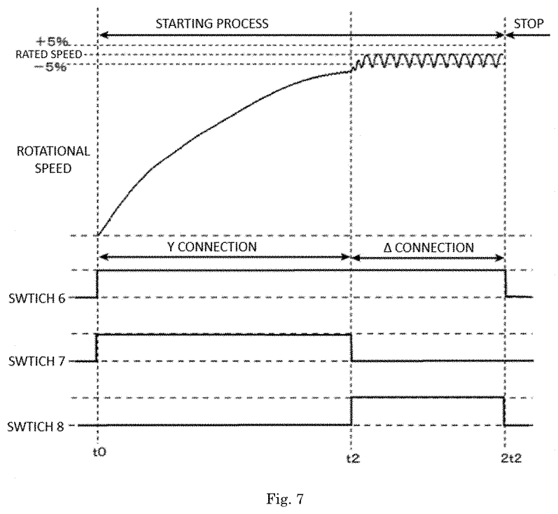

FIG. 7 is a diagram illustrating an exemplary operation of each unit of the motor drive system according to the present embodiment when the inertia is relatively large. In FIG. 7, the switch 6 is turned ON at t0, and turned OFF at 2t2. The switch 7 is turned ON at t0, turned OFF at t2, and the OFF state is maintained even after 2t2. The switch 8 is OFF at t0, turned ON at t2, and turned OFF at 2t2. The coils of the motor 1 are in the Y connection from t0 to t2 and in the A connection from t2 to 2t2.

In this case, since the rotational speed of the motor 1 remains out of ±5% of the rated speed until t2 has passed after the coils of the motor 1 is connected in the Y connection, the connection is switched to A connection after t2 has passed. After that, since the rotational speed does not fall within ±5% of the rated speed even after t2 has passed (at 2t2), it is determined that starting has failed. Accordingly, the starting process is terminated and the motor 1 is stopped.

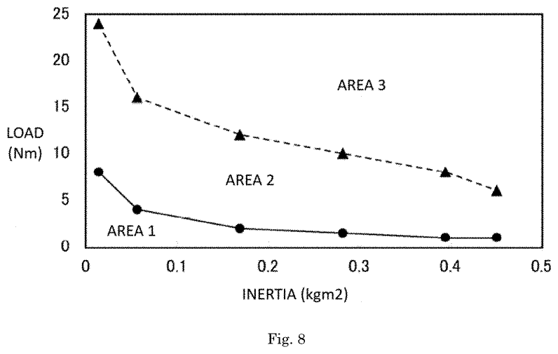

FIG. 8 is a diagram illustrating examples of inertia, loads, and successes and failures of starting in the conventional motor drive system and the motor drive system according to the present embodiment.

A solid line indicates an example of inertia, load, and success and failure of starting in the conventional motor drive system, and a broken line indicates an example of inertia, load, and success and failure of starting in the motor drive system according to the present embodiment.

In the conventional motor drive system, the motor is successfully started in the range of an area 1. Therefore, the activation fails in the range of an area 2 and an area 3.

On the other hand, in the motor drive system according to the present embodiment, the motor is successfully started in the range of the area 1 and the area 2.

Accordingly, in the present embodiment, even in the case where the inertia of a motor, a load, or the like is large, it is possible to improve the certainty of starting.

In S3 described above, an increase rate of the rotational speed of the motor 1 may be calculated, and the connection may not be switched to the A connection when the increase rate is equal to or greater than a predetermined threshold. In the case where the increase rate is equal to or greater than the predetermined threshold, that is, in the case where the inertia is relatively small and the motor 1 starts up fast, the state illustrated in FIG. 5 is obtained. Therefore, determination to switch the connection to the Δ connection is not made and, thus, the processing load can be reduced.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A method for starting a motor having a stator and a rotor, the method comprising:
starting the motor with a field coil of the stator being in Y connection;
switching connection of the field coil to Δ connection when a speed of the rotor does not fall within a predetermined range from a rated speed, within a predetermined time (t2); and
switching the connection of the field coil to the Y connection when the speed of the rotor falls within the predetermined range from the rated speed.

2. The method for starting the motor according to claim 1, wherein the motor is a reluctance motor.

3. The method for starting the motor according to claim 1, wherein the method further comprises, when the speed of the rotor does not fall within the predetermined range from the rated speed, within the predetermined time (t2), after the field coil is switched to the Δ connection, determining that the starting of the motor has failed.

4. The method for starting the motor according to claim 3, wherein the predetermined range is a range within ±5% of a rated number of rotations (speed) of the motor.

5. The method for starting the motor according to claim 3, wherein the predetermined time (t2) is set according to at least one of inertia of the motor and magnitude of a load.

6. The method for starting the motor according to claim 3, wherein the predetermined time (t2) is greater than 0 and within ⅓ of an estimated starting time of the motor.
